(19) United States
(12) Patent Application Publication
(10) Pub. No.: US 2025/0206027 A1
(43) Pub. Date: Jun. 26, 2025

(54) CHEMICAL SOLUTION ACCOMMODATION ASSEMBLY AND APPARATUS FOR SUPPLYING CHEMICAL SOLUTION

(71) Applicant: SEMES CO., LTD., Cheonan-si (KR)

(72) Inventors: Myungjin KIM, Cheonan-si (KR); Jinwoo YANG, Pyeongtaek-si (KR)

(73) Assignee: SEMES CO., LTD., Cheonan-si (KR)

(21) Appl. No.: 18/964,852

(22) Filed: Dec. 2, 2024

(30) Foreign Application Priority Data
Dec. 21, 2023 (KR) 10-2023-0189035

(51) Int. Cl. B41J 2/175; B41J 2/19

(52) U.S. Cl. CPC B41J 2/17553; B41J 2/17566; B41J 2/19; B41J 2002/17579

(57) ABSTRACT

A chemical solution accommodation assembly includes a reservoir body configured to receive a chemical solution therein, and formed of a nonconductive material, wherein a top of the reservoir body is at least partially open, a reservoir cover covering the partially opened top of the reservoir body to seal inside of the reservoir body and formed of a material having a melting point higher than a heating temperature of the chemical solution, a heating member configured to heat the chemical solution in the reservoir body through the reservoir cover and a level sensor unit installed on a side wall of the reservoir body, and configured to measure at least one levels of the chemical solution in the reservoir body.

### CROSS-REFERENCE TO RELATED APPLICATION

This application claims priority benefit of under 35 U.S.C. § 119 to Korean Patent Application No. 10-2023-0189035, filed on Dec. 21, 2023 in the Korean Intellectual Property Office (KIPO), the disclosures of which are herein incorporated by reference in their entirety.

### BACKGROUND

### 1. Field

Example embodiments relate to a chemical solution accommodation assembly and an apparatus for supplying chemical solution. More particularly, example embodiments relate to a chemical solution accommodation assembly and an apparatus for supplying chemical solution for storing a chemical solution to be supplied to an inkjet head.

### 2. Description of the Related Art

An apparatus for supplying chemical solution may supply a chemical solution to an inkjet head. The apparatus for supplying chemical solution may include a heating member for maintaining the chemical solution at a constant temperature such as a heater. In order to efficiently transfer heat from the heater and safely operate the heater, the reservoir on which the heating member is disposed may include a metal-based material having a high melting point so as not to be deformed by heat provided by the heater.

However, when the apparatus for supplying chemical solution is configured with a metal-based material, there is a limit when attaching a sensor to check level of the chemical solution. Thus, prior art attempts to solve the problem by providing a separate viewing window or an additional tube for checking the level of the chemical solution outside the apparatus for supplying chemical solution, but when the chemical solution is exposed to the outside, the chemical solution may be deformed, thereby causing another problem. Accordingly, there is a need for an apparatus for supplying chemical solution capable of simultaneously operating the heating member and a sensor for detecting a level.

### SUMMARY

Example embodiments provide a chemical solution accommodation assembly capable of simultaneously operating a heating member and a water level sensor.

Example embodiments provide an apparatus for supplying chemical solution including the chemical solution accommodation assembly.

According to example embodiments, a chemical solution accommodation assembly includes a reservoir body configured to receive a chemical solution therein, and formed of a nonconductive material, wherein a top of the reservoir body is at least partially open, a reservoir cover covering the partially opened top of the reservoir body to seal inside of the reservoir body and formed of a material having a melting point higher than a heating temperature of the chemical solution, a heating member configured to heat the chemical solution in the reservoir body through the reservoir cover and a level sensor unit installed on a side wall of the reservoir body, and configured to measure at least one levels of the chemical solution in the reservoir body.

According to example embodiments, a chemical solution accommodation assembly includes a reservoir body configured to receive a chemical solution therein, and formed of a nonconductive material, wherein a top of the reservoir body is at least partially open, a reservoir cover covering the partially opened top of the reservoir body to seal inside of the reservoir body, and formed of a material having a melting point higher than a heating temperature of the chemical solution, a heating member configured to heat the chemical solution in the reservoir body through the reservoir cover and a sealing member disposed between the upper surface of the reservoir body and a lower surface of the reservoir cover to prevent the chemical solution from being exposed.

According to example embodiments, an apparatus for supplying chemical solution includes an ink supply member storing a chemical solution, a first chemical solution accommodation assembly receiving the chemical solution from the ink supply member and storing the chemical solution therein and a second chemical accommodation assembly receiving the chemical solution from the first chemical solution accommodation assembly and storing the chemical solution therein, wherein at least one of the first chemical solution accommodation assembly and the second chemical solution accommodation assembly include, a reservoir body configured to receive a chemical solution therein, and formed of a nonconductive material, wherein a top of the reservoir body is at least partially open, a reservoir cover covering the partially opened top of the reservoir body to seal inside of the reservoir body, and formed of a material having a melting point higher than a heating temperature of the chemical solution, a heating member configured to heat the chemical solution in the reservoir body through the reservoir cover and a level sensor unit installed on a side wall of the reservoir body, and configured to measure at least one levels of the chemical solution in the reservoir body.

According to example embodiments, a chemical solution accommodation assembly includes a reservoir body configured to receive a chemical solution therein, and formed of a nonconductive material, wherein a top of the reservoir body is at least partially open, a reservoir cover covering the partially opened top of the reservoir body to seal inside of the reservoir body and formed of a material having a melting point higher than a heating temperature of the chemical solution, a heating member configured to heat the chemical solution in the reservoir body through the reservoir cover and a level sensor unit installed on a side wall of the reservoir body, and configured to measure at least one levels of the chemical solution in the reservoir body.

Since the reservoir body and the reservoir cover may include different materials, the chemical solution accommodation assembly has an advantage of directly heating the chemical solution by operating a heating member and a water level sensor in one chemical solution accommodation assembly.

In addition, since there is no need to have a separate viewing window or water level check tube, a possibility of deformation of the chemical solution by an external light source is reduced, and the space efficiency to accommodate the chemical solution is increased.

The apparatus for supplying chemical solution including the chemical solution accommodation assembly according to example embodiments may supply a chemical solution of a certain temperature in a process that requires rapid supply of the chemical solution, so process reliability and productivity may be expected to be improved.

However, the effects of this invention are not limited to the above-mentioned effects, and may be variously extended without departing from the spirit and region of this invention.

### BRIEF DESCRIPTION OF THE DRAWINGS

Example embodiments will be more clearly understood from the following detailed description taken in conjunction with the accompanying drawings. FIGS. 1 to 9 represent non-limiting, example embodiments as described herein.

FIG. 1 is a perspective view illustrating a chemical solution accommodation assembly in accordance with example embodiments.

FIG. 2 is an exploded perspective view illustrating the chemical solution accommodation assembly of FIG. 1.

FIG. 3 is a plan view illustrating the chemical solution accommodation assembly of FIG. 1.

FIG. 4 is a cross-sectional view taken along line A-A′ of FIG. 3.

FIG. 5 is a cross-sectional view taken along line B-B′ of FIG. 4.

FIG. 6 is a cross-sectional view illustrating a reservoir cover of the chemical solution accommodation assembly of FIG. 1.

FIG. 7 is a cross-sectional view illustrating a heater head separated from the reservoir cover of FIG. 6.

FIG. 8 is a block diagram illustrating a negative pressure supply member and a circulation reservoir connected to the chemical solution accommodation assembly of FIG. 1.

FIG. 9 is a block diagram illustrating an apparatus for supplying chemical solution in accordance with example embodiments.

### DETAILED DESCRIPTION OF EXAMPLE EMBODIMENTS

Hereinafter, example embodiments will be explained in detail with reference to the accompanying drawings, wherein like reference characters denote like elements, unless otherwise noted.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” etc, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, the device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present. Similarly, when an element is referred to as being “on” or “connected to” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

When the terms “about” or “substantially” are used in this specification in connection with a numerical value and/or geometric terms, it is intended that the associated numerical value includes a manufacturing tolerance (e.g., +10%) around the stated numerical value. Further, regardless of whether numerical values and/or geometric terms are modified as “about” or “substantially,” it will be understood that these values should be construed as including a manufacturing or operational tolerance (e.g., +10%) around the stated numerical values and/or geometric. When referring to “within a range of C to D”, this means C inclusive to D inclusive unless otherwise specified.

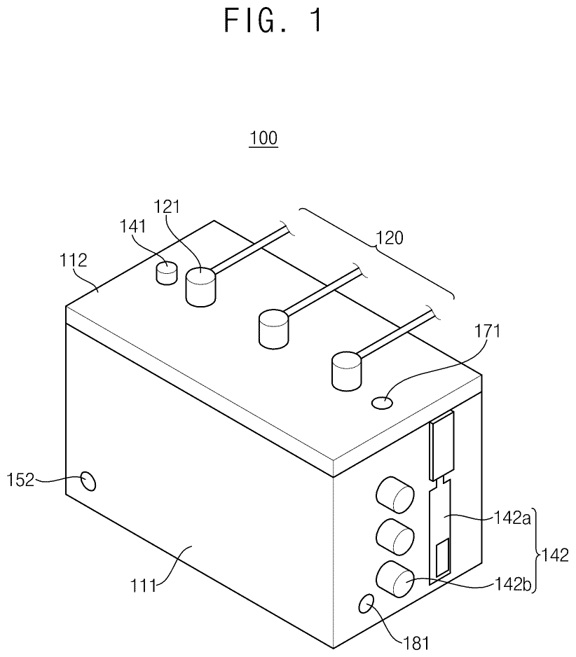

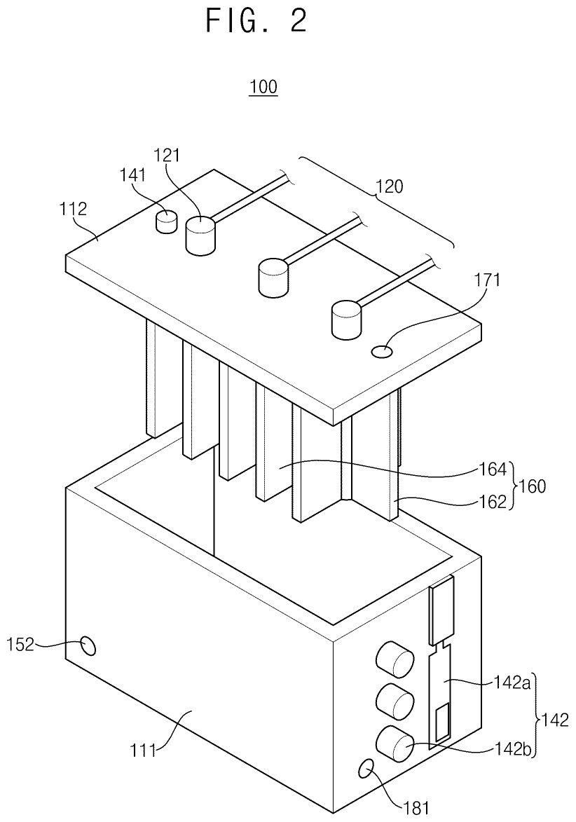

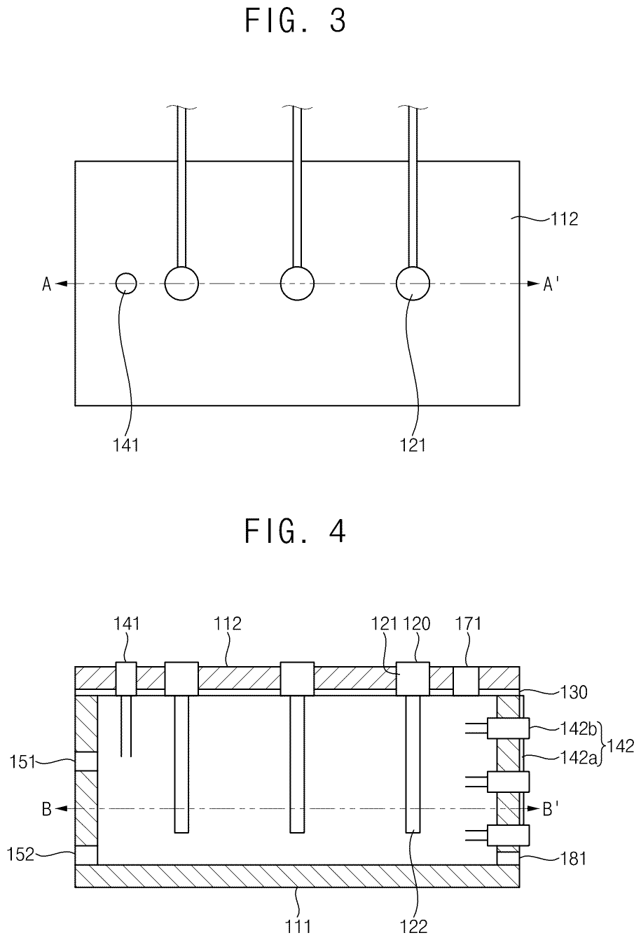

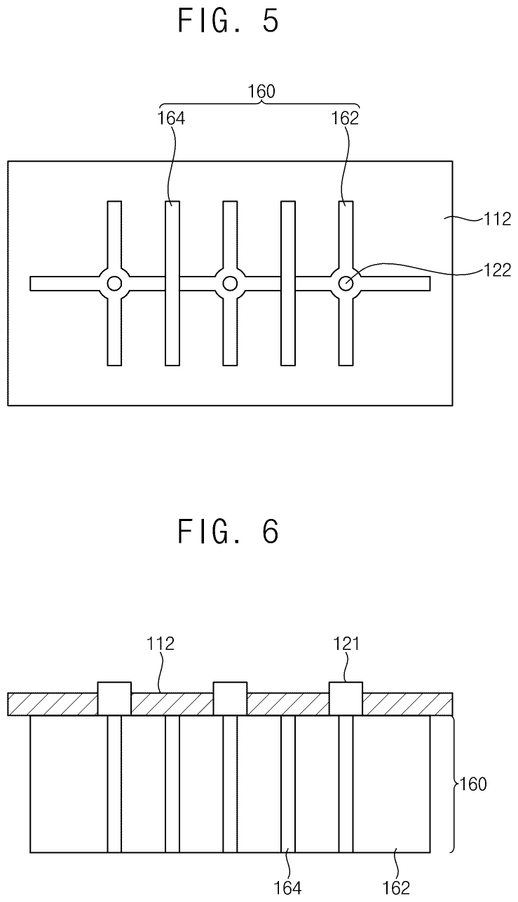

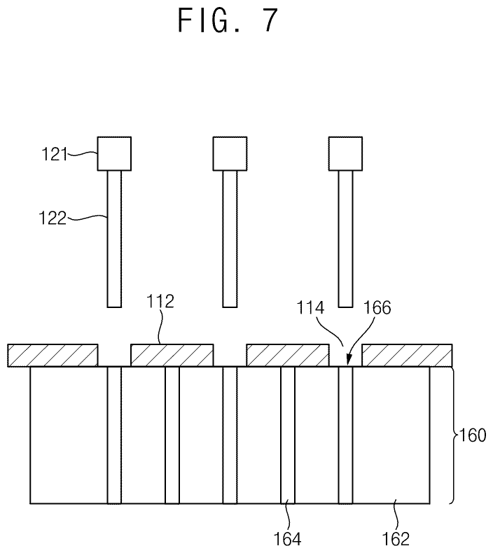

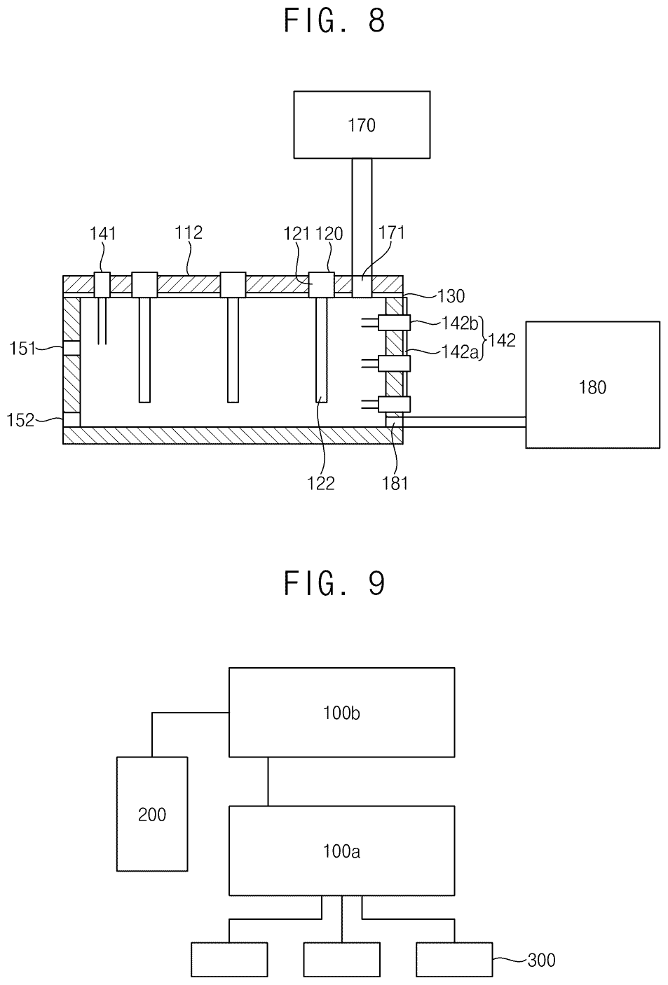

FIG. 1 is a perspective view illustrating a chemical solution accommodation assembly in accordance with example embodiments. FIG. 2 is an exploded perspective view illustrating the chemical solution accommodation assembly of FIG. 1. FIG. 3 is a plan view illustrating the chemical solution accommodation assembly of FIG. 1. FIG. 4 is a cross-sectional view taken along line A-A′ of FIG. 3. FIG. 5 is a cross-sectional view taken along line B-B′ of FIG. 4. FIG. 6 is a cross-sectional view illustrating a reservoir cover of the chemical solution accommodation assembly of FIG. 1. FIG. 7 is a cross-sectional view illustrating a heater head separated from the reservoir cover of FIG. 6. FIG. 8 is a block diagram illustrating a negative pressure supply member and a circulation reservoir connected to the chemical solution accommodation assembly of FIG. 1.

Referring to FIGS. 1 to 8, a chemical solution accommodation assembly 100 may include a reservoir body 111, a reservoir cover 112, level sensor unit 142, and a heating member 120. Also, the chemical solution accommodation assembly 100 may further include at least one temperature sensor 141, a sealing member 130, etc.

In example embodiments, the chemical solution accommodation assembly 100 may be used to manufacture a display device. For example, the chemical solution accommodation assembly 100 may receive a chemical solution supplied from an ink supply member therein and provide the chemical solution to an inkjet head capable of discharging the chemical solution.

In example embodiments, the reservoir body 111 may have a rectangular parallelepiped shape. The reservoir body 111 may accommodate a chemical solution therein. The chemical solution may include a photocurable ink. The reservoir body 111 may have a shape in which an upper surface is opened. The upper surface of the reservoir body 111 may be opened to expose an inside of the reservoir body 111. The reservoir body 111 may include a nonconductive material. Since the reservoir body 111 may include the nonconductive material, an electrical water level sensor may be operated on the reservoir body 111, as will be described later. The nonconductive material may include a resin-based material. For example, the resin-based material may include a material having good chemical resistance and heat resistance and low reactivity, such as perfluoroalkoxy (PFA), polytetrafluoroethylene (PTFE), etc. Accordingly, the reservoir body 111 may accommodate various kinds of chemical solutions.

The reservoir cover 112 may have a shape corresponding to a shape of the upper surface to cover the upper surface of the reservoir body 111. The reservoir cover 112 may be disposed on the upper surface to cover the inside of the reservoir body 111. The reservoir cover 112 may include a metal-based material. For example, the metal-based material may include a material having high thermal conductivity, such as aluminum. Since the reservoir cover 112 includes the metal-based material, the heating members may be operated on the reservoir cover 112 as will be described later. The metal-based material may include a material having a melting point higher than the heating temperature of the heating member so as not to be deformed by heat supplied by the heating member.

The sealing member 130 may be interposed between the open upper surface of the reservoir body 111 and a bottom surface of the reservoir cover 112. The sealing member 130 may be interposed between the reservoir cover 112 and the reservoir body 111 coupled to each other to prevent leakage of the chemical solution accommodated therein. Particularly, the sealing member may be interposed between the upper surface of the reservoir body 111 and the bottom surface of the reservoir cover 112. The sealing member may include an O-ring or a gasket.

In example embodiments, the level sensor unit 142 may be a sensor for detecting water level of the chemical solution inside the reservoir body 111. The level sensor unit 142 may be disposed on one sidewall of the reservoir body 111. The level sensor unit 142 may include an electrical level sensor to electrically measure a level of the chemical solution in the reservoir body 111. For example, the level sensor unit 142 may include at least one of a non-contact-type capacitive water level sensor 142a and a contact-type capacitive water level sensor 142b.

As shown in FIGS. 1 and 2, level sensor unit 142 may include the non-contact-type water level sensor 142a. The non-contact-type water level sensor 142a may be disposed on the one sidewall of the reservoir body 111. The non-contact-type water level sensor 142a may have a tape shape extending from an upper portion to a lower portion of the one sidewall of the reservoir body 111. The non-contact-type water level sensor 142a includes a display window and an adhesive electrode, and may detect a water level by converting a capacitance value detected through the adhesive electrode into water level information without directly contacting the chemical solution inside the reservoir body 111.

The non-contact-type water level sensor 142a may measure the water level using an electric field. Since the non-contact-type water level sensor 142a uses the electric field, it may not be operated in a chemical solution storage made of a conductor such as a metal material. The chemical solution accommodation assembly 100 in accordance with example embodiments has an advantage of operating the non-contact-type water level sensor 142a as the reservoir body 111 includes the nonconductive material.

The level sensor unit 142 may include the contact-type water level sensor 142b. Particularly, the level sensor unit 142 may include a plurality of the contact-type water level sensors 142b. The contact-type water level sensor 142b may be provided to penetrate the one sidewall of the reservoir body 111 and may directly contact the chemical solution accommodated in the reservoir body 111.

The contact-type water level sensor 142b may detect a water level of the chemical solution accommodated in the reservoir body 111. The contact-type water level sensor 142b may detect information on the water level and control the water level to be maintained constant. The contact-type water level sensor 142b may include a plurality of contact-type water level sensors 142b arranged along one sidewall of the reservoir body 111. The plurality of contact-type water level sensors 142b may be vertically spaced apart from each other along the one sidewall of the reservoir body 111. For example, the plurality of contact-type water level sensors 142b may be installed at a plurality of water level points on one sidewall of the reservoir body 111.

The contact-type water level sensors 142b may perform different roles depending on height that is, water level point. For example, a contact-type water level sensor 142b positioned close to the upper surface of the reservoir body 111 may control an excessive supply of the chemical solution, and a contact-type water level sensor 142b positioned close to the lower surface of the reservoir body 111 may detect an amount of a residual chemical solution after discharge of the chemical solution is completed.

In example embodiments, the heating member 120 may be disposed on the reservoir cover 112 to heat the chemical solution accommodated in the reservoir body 111.

The heating member 120 may include a heating member that heats by direct contact with the chemical solution. For example, the heating member 120 may include at least one heater head 121 and a heating rod 122.

The at least one heater head 121 may include a plurality of heater heads 121 disposed on the reservoir cover 112 to be spaced apart from each other to uniformly heat the chemical solution therein. For example, a plurality of heater heads 121 may be arranged in a line or may be arranged in a zigzag shape on an upper surface of the reservoir cover 112. The heater head 121 may be disposed to penetrate the reservoir cover 112, and the heating rod 122 may be disposed on a lower surface of the heater head 121. The heating rod 122 may extend vertically downward from the lower surface of the heater head 121 and may directly contact the chemical solution accommodated in the reservoir body 111.

In example embodiments, the chemical solution accommodation assembly 100 may further include a heat dissipation plate 160. As illustrated in FIGS. 5 to 7, the heat dissipation plate 160 may extend vertically downward from the lower surface of the heater head 121 while surrounding an outer circumferential surface of the heating rod 122. The heat dissipation plate 160 may include a material having high thermal conductivity, such that heat transferred from the heater head 121 to the heating rod 122 is transferred in direct contact with the chemical solution, thereby uniformly heating the chemical solution. The heat dissipation plate 160 may include a metal material.

The heat dissipation plate 160 may be placed to surround each of a plurality of heating rods 122. The heat dissipation plate 160 may include a plurality of radial heat dissipation plates 162 extending from an outer circumferential surface of each of a plurality of heating rods 122 and connection plates 164 connecting the radial heat dissipation plates 162 to each other. The plurality of radial heat dissipation plates 162 may extend in a plurality of radial directions in a predetermined section in a vertical direction of the outer circumferential surface of each of a plurality of heating rods 122. For example, the heat dissipation plate 160 may include a plurality of radial heat dissipation plates 162 extending in four directions up, down, left, and right around the heating rod 122 when viewed in a plan view. By providing the heat dissipation plate 160, the heat transferred from the heater head 121 to the heating rod 122 may be evenly distributed to the chemical solution, stabilizing the temperature distribution of the chemical solution. It may prevent only specific areas of the chemical solution from reaching high temperature, thereby avoiding thermal deformation of the reservoir body 111 including the resin-based material.

As illustrated in FIG. 7, the heat dissipation plate 160 in accordance with embodiments may be disposed to be integrally coupled to the reservoir cover 112. The reservoir cover 112 may be provided with a plurality of first through holes 114 penetrating the reservoir cover 112 and exposing the heat dissipation plate 160. A diameter and a shape of the plurality of first through holes 114 may be provided to correspond to a diameter and a shape of the heater head 121. The heat dissipation plate 160 may include a plurality of first and connection plates 162 and 164 radially extending with respect to a plurality of the first through holes 114. For example, the heat dissipation plate 160 may include radial heat dissipation plates 162 extending in four vertical directions with respect to a plurality of first through holes 114 when viewed in a plan view. The radial heat dissipation plates may have second through holes 166 penetrating the heat dissipation plate 160 in a height direction perpendicular to the vertical direction in which the radial heat dissipation plates 162 extend, respectively, where a plurality of first through holes 114 are located. A diameter and a shape of the second through-holes 166 may be provided to correspond to a diameter and a shape of the heating rod 122. As illustrated in FIG. 6, the heater head 121 and the heating rod 122 may be coupled to the first through-holes 114 of the reservoir cover 112 and the second through-holes 166 of the heat dissipation plate 160 to serve as a heater. In example embodiments, at least one temperature sensor 141 may be disposed on the upper surface of the reservoir cover 112 to detect a temperature of the chemical solution accommodated in the reservoir body 111. Although not shown in the drawings, the temperature sensor 141 may control the heating temperature of the heating member 120 through the controller by transmitting the temperature of the detected chemical solution to the controller. The temperature sensor may include both a contact-type sensor and a non-contact-type sensor.

In example embodiments, as illustrated in FIG. 8, the chemical solution accommodation assembly 100 may further include a negative pressure supply member 170 and a circulation reservoir 180.

The chemical solution accommodation assembly 100 may be connected to the circulation reservoir 180 through a circulation connection line 181 that is located on the one sidewall of the reservoir body 111. The circulation reservoir 180 may circulate the chemical solution accommodated in the chemical solution accommodation assembly 100 so that the chemical solution is evenly heated. Although not shown in the drawings, the circulation reservoir 180 may additionally include a pump for circulating the chemical solution, and the chemical solution accommodation assembly 100 may include a partition wall inside the reservoir body 111 to guide the flow of the chemical solution. By providing the circulation reservoir 180, a temperature distribution of the chemical solution may be stabilized, and only a specific portion of the chemical solution is prevented from being at a high temperature, thereby preventing thermal deformation of the reservoir body 111 made of a resin-based material.

The chemical solution accommodation assembly 100 may be connected to the negative pressure supply member 170 through a negative pressure connection line 171 located on the upper surface of the reservoir cover 112. The negative pressure supply member 170 may be connected to the upper surface of the reservoir cover 112 to provide negative pressure to the inside of the chemical solution accommodation assembly. Accordingly, air bubbles generated when the chemical solution is heated or circulated may be collected.

The reservoir body 111 may include an inlet 151 on the one sidewall and an outlet 152 on the one sidewall or the lower surface thereof. Although not shown in the drawing, an inclined flow path for guiding the chemical solution contained in the reservoir body 111 to the outlet is provided so that the chemical solution may be efficiently supplied.

As described above, the chemical solution accommodation assembly 100 may include the reservoir body 111 having an open upper surface, the reservoir cover 112 coupled to be sealed with the upper surface by the sealing member 130, the water level sensor 142 disposed on the one sidewall of the reservoir body 111, and the heating member 120 disposed on the reservoir cover 112.

The reservoir body 111 may include a nonconductive material, for example a resin-based material. The reservoir cover 112 may include a material having a melting point higher than the heating temperature of the heating member 120, for example, a metal material. Accordingly, the chemical solution may be heated by operating the heating member 120 on the reservoir cover 112, and the level of the chemical solution may be detected by operating a capacitive water level sensor on the reservoir body 111.

Accordingly, in contrast to prior art, which requires a separate viewing window or a water level check tube to detect a level of the chemical solution inside, the chemical solution accommodation assembly according to the example embodiments has an advantage of increasing space efficiency because the heating member and the capacitive water level sensor can be operated simultaneously on one chemical solution accommodation assembly. In addition, since a separate viewing window is not provided, deformation of the chemical solution by an external light source can be prevented.

Hereinafter, an apparatus for supplying chemical solution including the chemical solution accommodation assembly of FIG. 1 will be described.

FIG. 9 is a block diagram illustrating an apparatus for supplying chemical solution in accordance with example embodiments.

Referring to FIG. 9, an apparatus for supplying chemical solution 10 may include an ink supply member 200, a first chemical solution accommodation assembly 100a, a second chemical solution accommodation assembly 100b, and a plurality of inkjet heads 300.

Referring to FIG. 9, the apparatus for supplying chemical solution 10 may be used in a process of supplying the chemical solution onto the substrate to form pixels on the substrate. In other words, the chemical solution supply device 10 may be used in various processes for manufacturing a display device.

In example embodiments, the ink supply member 200 may supply a chemical solution to the second chemical solution accommodation assembly 100b. The second chemical solution accommodation assembly 100b may serve as a buffer reservoir by temporarily storing the chemical solution before providing the chemical solution contained therein to the first chemical solution accommodation assembly 100a. The second chemical solution accommodation assembly 100b may supply the chemical solution to the first chemical solution accommodation assembly 100a. The first chemical solution accommodation assembly 100a may include a plurality of inkjet heads 300. The inkjet heads 300 may receive the chemical solution from the first chemical solution accommodation assembly 100a and discharge the droplets onto the substrate.

In example embodiments, at least one of the first chemical solution accommodation assembly 100a and the second chemical solution accommodation assembly 100b may include the chemical solution accommodation assembly of FIG. 1.

In example embodiments, the first chemical solution accommodation assembly 100a and the second chemical solution accommodation assembly 100b may include the chemical solution accommodation assembly of FIG. 1. In a process in which the chemical solution is rapidly supplied, when there is not enough time for the chemical solution to be heated in the second chemical solution accommodation assembly 100b, the chemical solution may be preliminarily heated in the first chemical solution accommodation assembly 100a and then supplied to the second chemical solution accommodation assembly 100b.

The foregoing is illustrative of example embodiments and is not to be construed as limiting thereof. Although a few example embodiments have been described, those skilled in the art will readily appreciate that many modifications are possible in some example embodiments without materially departing from the novel teachings and advantages of the present invention. Accordingly, all such modifications are intended to be included within the scope of example embodiments as defined in the claims.

What is claimed is:

1. A chemical solution accommodation assembly comprising:
a reservoir body configured to receive a chemical solution therein, and formed of a nonconductive material, wherein a top of the reservoir body is at least partially open;
a reservoir cover covering the partially opened top of the reservoir body to seal inside of the reservoir body, and formed of a material having a melting point higher than a heating temperature of the chemical solution;
a heating member configured to heat the chemical solution in the reservoir body through the reservoir cover; and
a level sensor unit installed on a side wall of the reservoir body, and configured to measure at least one levels of the chemical solution in the reservoir body.

2. The chemical solution accommodation assembly of claim 1, wherein the reservoir body includes a resin-based material, and the reservoir cover includes a metal material.

3. The chemical solution accommodation assembly of claim 1, wherein the heating member includes:
a plurality of heater heads configured to penetrate the reservoir cover, the plurality of heater heads arranged in a row or in a zigzag shape on an upper surface of the reservoir cover; and
a plurality of heating rods extending vertically downward from a lower surface of each of the plurality of heater heads and transferring heat to the chemical solution in the reservoir body.

4. The chemical solution accommodation assembly of claim 3, wherein the heating member further comprises:
radial heat dissipation plates extending in a plurality of radial directions in a predetermined vertical section of an outer circumferential surface of each of the plurality of heating rods.

5. The chemical solution accommodation assembly of claim 4, wherein the radial heat dissipation plates extending in four directions: up, down, left, and right around each of the plurality of heating rods when viewed from a plan view; and
the heating member comprises:
first heating rod;
a second heating rod adjacent to the first heating rod; and
a connecting radial heat dissipation plates connecting radial heat dissipation plates extending in the left and right directions on side surfaces of each of the first heating rod and the second heating rod, and extending in the up and down directions.

6. The chemical solution accommodation assembly of claim 1, wherein the reservoir body is connected to a circulating reservoir configured to circulate the chemical solution through a circulating connection line provided on one sidewall of the reservoir body.

7. The chemical solution accommodation assembly of claim 1, wherein a level sensor unit is an electrical level sensor to electrically measure a level of the chemical solution in the reservoir body.

8. The chemical solution accommodation assembly of claim 1, further comprises:
at least one temperature sensor configured to penetrate the reservoir cover.

9. The chemical solution accommodation assembly of claim 1, wherein the reservoir body is connected to a negative pressure supply member for collecting bubbles of the chemical solution by providing negative pressure in the reservoir body through a negative pressure connection line disposed on the reservoir cover.

10. A chemical solution accommodation assembly comprising:
a reservoir body configured to receive a chemical solution therein, and formed of a nonconductive material, wherein a top of the reservoir body is at least partially open;
a reservoir cover covering the partially opened top of the reservoir body to seal inside of the reservoir body, and formed of a material having a melting point higher than a heating temperature of the chemical solution;
a heating member configured to heat the chemical solution in the reservoir body through the reservoir cover; and
a sealing member disposed between the upper surface of the reservoir body and a lower surface of the reservoir cover to prevent the chemical solution from being exposed.

11. The chemical solution accommodation assembly of claim 10, wherein the reservoir body includes a resin-based material, and the reservoir cover includes a metal material.

12. The chemical solution accommodation assembly of claim 11, wherein the heating member includes:
a plurality of heater heads configured to penetrate the reservoir cover, the plurality of heater heads arranged in a row or in a zigzag shape on an upper surface of the reservoir cover; and
a plurality of heating rods extending vertically downward from a lower surface of each of the plurality of heater heads and transferring heat to the chemical solution in the reservoir body.

13. The chemical solution accommodation assembly of claim 12, wherein the heating member further comprises:
radial heat dissipation plates extending in a plurality of radial directions in a predetermined vertical section of an outer circumferential surface of each of the plurality of heating rods.

14. The chemical solution accommodation assembly of claim 13, wherein the radial heat dissipation plates extending in four directions: up, down, left, and right around each of the plurality of heating rods when viewed from a plan view; and
the heating member comprises:
first heating rod;
a second heating rod adjacent to the first heating rod; and
a connecting radial heat dissipation plates connecting radial heat dissipation plates extending in the left and right directions on side surfaces of each of the first heating rod and the second heating rod, and extending in the up and down directions.

15. The chemical solution accommodation assembly of claim 10, further comprises:
a level sensor unit installed on a side wall of the reservoir body, and configured to measure at least one levels of the chemical solution in the reservoir body.

16. The chemical solution accommodation assembly of claim 15, wherein a level sensor unit is an electrical level sensor to electrically measure a level of the chemical solution in the reservoir body.

17. The chemical solution accommodation assembly of claim 10, further comprises:
at least one temperature sensor configured to penetrate the reservoir cover.

18. The chemical solution accommodation assembly of claim 10, wherein the reservoir body is connected to a negative pressure supply member for collecting bubbles of the chemical solution by providing negative pressure in the reservoir body through a negative pressure connection line disposed on the reservoir cover.

19. An apparatus for supplying chemical solution comprising:
an ink supply member storing a chemical solution;
a first chemical solution accommodation assembly receiving the chemical solution from the ink supply member and storing the chemical solution therein; and
a second chemical accommodation assembly receiving the chemical solution from the first chemical solution accommodation assembly and storing the chemical solution therein;
wherein at least one of the first chemical solution accommodation assembly and the second chemical solution accommodation assembly include:
a reservoir body configured to receive a chemical solution therein, and formed of a nonconductive material, wherein a top of the reservoir body is at least partially open;
a reservoir cover covering the partially opened top of the reservoir body to seal inside of the reservoir body, and formed of a material having a melting point higher than a heating temperature of the chemical solution;
a heating member configured to heat the chemical solution in the reservoir body through the reservoir cover; and
a level sensor unit installed on a side wall of the reservoir body, and configured to measure at least one levels of the chemical solution in the reservoir body.

20. The apparatus for supplying chemical solution of claim 19, wherein the heating member includes:
a plurality of heater heads configured to penetrate the reservoir cover, the plurality of heater heads arranged in a row or in a zigzag shape on an upper surface of the reservoir cover;
a plurality of heating rods extending vertically downward from a lower surface of each of the plurality of heater heads and transferring heat to the chemical solution in the reservoir body; and
radial heat dissipation plates extending in a plurality of radial directions in a predetermined vertical section of an outer circumferential surface of each of the plurality of heating rods.
